(19) United States
(12) Patent Application Publication
(10) Pub. No.: US 2016/0132220 A1
(43) Pub. Date: May 12, 2016

(54) SYSTEM AND METHOD FOR INVENTORY COUNTING

(71) Applicant: INDIGO CORPORATION LIMITED, Hong Kong (HK)

(72) Inventors: Eric See-kit Chiu, Hong Kong (HK); Jonathan See Chai Chiu, Hong Kong (HK)

(73) Assignee: INDIGO CORPORATION LIMITED

(21) Appl. No.: 14/712,922

(22) Filed: May 15, 2015

(30) Foreign Application Priority Data
Nov. 11, 2014 (HK) 14111408.7

(51) Int. Cl. G06F 3/0484; G06F 3/0488

(52) U.S. Cl. CPC G06F 3/04845; G06F 3/04842; G06F 3/0488

(57) ABSTRACT

A method for inventory counting includes: representing a container by an image of the container displayed on a display; setting up a full level of a content on the image corresponding to the content being considered full in the container by making a first haptic gesture to the display; setting up an empty level of the content on the image corresponding to the container being considered empty of the content by making a second haptic gesture to the display; determining a current level of the content remaining in the container on the image and marking the current level by making a third haptic gesture to the display; calculating a proportion of the content remaining in the container based on the current level, the full level and the empty level on the image; and recording the calculated proportion of the content remaining in the container.

### CROSS-REFERENCE TO RELATED APPLICATIONS

This application claims the benefit of Hong Kong short-term patent application No. 14111408.7 filed on Nov. 11, 2014; the contents of which is hereby incorporated by reference.

### FIELD OF THE PATENT APPLICATION

The present patent application generally relates to inventory management technologies and more specifically to a system and a method for inventory counting that involve recording and calculating content proportion remaining in a container regardless of its shape or size.

### BACKGROUND

A convention procedure of counting inventory items with partial content (non-whole units), such as a half-poured bottle of liquor or wine, in establishments that carry such products, such as a bar or restaurant, requires that a user “eyeballs” (estimate by looking) the level of the content remaining in the container to the tune of a tenth of a unit (e.g. 0.1, 0.2, etc. out of 1 full bottle). This value is then written down on a piece of paper with a pen or pencil. This process is repeated for the same item in each of locations where it is stored (e.g. storage, main bar, side bar). The values are then added up to give a total stock count value for that item in the establishment. This process is repeated for every item, which typically ranges from a couple hundred items in a small establishment to the high hundreds in a larger establishment.

Another method of partial counting currently employed by some establishments involves the weighing of items. A scale is zero-calibrated to the weight of an empty container of the item to be counted, and the partially consumed item is put on the scale to calculate the weight of the remaining liquid in that container. This weight value is divided by the weight value of the liquid in a full container of that item to get the remaining proportion value of that partially consumed item. This process is again repeated for that item in each of the locations it is in. The count values in each location have to be added up manually to obtain a total count of that item in the entire establishment. This process is again repeated for every item in the establishment.

There are a few other methods currently employed for partial counting. One such method involves the use of a specially designed ruler with clear markings tailored to different shaped bottles to allow stock takers to more accurately pinpoint the content level instead of just “eyeballing” it. Other methods involve the use of specially designed hardware that has to be bought separately. Some connect to measuring apparatus like a scale to reduce manual data entry, while another involves the use of a stylus to pinpoint the content level line on a screen of a custom hardware.

It is desired, however, to have a system and a method for inventory counting that provide a solution that is fast, efficient, accurate, easily-accessible, and affordable enough.

### SUMMARY

The present patent application is directed to a method for inventory counting. In one aspect, the method includes: representing a container by an image of the container displayed on a display; setting up a full level of a content on the image corresponding to the content being considered full in the container by making a first haptic gesture to the display; setting up an empty level of the content on the image corresponding to the container being considered empty of the content by making a second haptic gesture to the display; determining a current level of the content remaining in the container on the image and marking the current level by making a third haptic gesture to the display; calculating a proportion of the content remaining in the container based on the current level, the full level and the empty level on the image; and recording the calculated proportion of the content remaining in the container.

The first, second, and third haptic gestures may include a tapping gesture or a dragging gesture. Coordinates of the current level, the full level and the empty level on the image in a depth direction of the container may be used in calculating the proportion of the content remaining in the container.

The method may further include switching to processing another image representing another container based on a swiping gesture. The method may further include determining whether to switch to the other image based on whether absolute value of a haptic displacement associated with the swiping gesture is greater than a predetermined threshold; and determining whether to switch to a left image or switch to a right image based on whether the haptic displacement is positive or negative.

In another aspect, the method for inventory counting includes: representing a container by a virtual object displayed on a display; setting up a full level of a content on the virtual object corresponding to the content being considered full in the container by making a first haptic gesture to the display; determining a current level of the content remaining in the container on the virtual object and marking the current level by making a second haptic gesture to the display; and calculating and recording a proportion of the content remaining in the container based on the current level and the full level on the virtual object.

The virtual object may be an image of the container or a row in an item list. The method may further include adjusting width of a colored translucent box that overlays the row by a user with a haptic gesture, wherein width of the row represents the full level of the content in the container, while the width of the box represents the current level of the content remaining in the container. The row may be divided into a predetermined number of intervals, while the box may only overlay one or a plurality of the intervals within the row.

The method for inventory counting may further include updating a total amount of the content remaining in different containers in a list of items based on the amount of content remaining in each container in the list.

The method may further include setting up an empty level of the content on the virtual object corresponding to the container being considered empty of the content by making a third haptic gesture to the display, wherein coordinates of the current level, the full level and the empty level in a depth direction of the virtual object are used in calculating the proportion of the content remaining in the container.

The current level may be determined to be equal to the full level if a coordinate associated with the second haptic gesture is greater than the coordinate of the full level. The current level may be determined to be equal to the empty level if the coordinate associated with the second haptic gesture is smaller than the coordinate of the empty level.

The method may further include defining an outline on an outline layer over the virtual object when the content in the container is at the full level, filling the outline with colored pixels, and counting the number of colored pixels. The method may further include counting number of pixels below the current level within the outline. The first and second haptic gestures may include a tapping gesture or a dragging gesture.

In yet another aspect, the present patent application provides a system for inventory counting. The system includes: a display; a touch controller; a processor in communication with the touch controller; and a main controller in communication with the processor regarding haptic signals applied to the display and recorded by the touch controller. The processor is configured to represent a container by an image of the container and display the image on a display; set up a full level of a content on the image corresponding to the content being considered full in the container by a haptic gesture from a user; set up an empty level of the content on the image corresponding to the container being considered empty of the content by a haptic gesture from the user; determine a current level of the content remaining in the container on the image indicated by a haptic gesture from the user; calculate a proportion of the content remaining in the container based on the current level, the full level and the empty level on the image; and record the calculated proportion of the content remaining in the container.

The first, second, and third haptic gestures may include a tapping gesture or a dragging gesture. The processor may be configured to calculate the proportion of the content remaining in the container based on coordinates of the current level, the full level and the empty level on the image in a depth direction of the container.

The processor may be configured to switch to processing another image representing another container based on a swiping gesture. The processor may be configured to determine whether to switch to the other image based on whether absolute value of a haptic displacement associated with the swiping gesture is greater than a predetermined threshold; and to determine whether to switch to a left image or switch to a right image based on whether the haptic displacement is positive or negative.

### BRIEF DESCRIPTIONS OF THE DRAWINGS

FIG. 1 illustrates an electronic system in accordance with an embodiment of the present patent application.

FIG. 2A illustrates processing operations associated with a setup process for a Linear Method of calculating the proportion of content remaining in a container in accordance with an embodiment of the present patent application.

FIG. 2B illustrates processing operations associated with a setup process for an Area Method of calculating the proportion of content remaining in a container implemented in accordance with an embodiment of the present patent application.

FIG. 3A illustrates processing operations associated with a recording and calculating process for the Linear Method of calculating the proportion of content remaining in a container in accordance with the embodiment depicted in FIG. 2A.

FIG. 3B illustrates processing operations associated with a recording and calculating process for the Area Method of calculating the proportion of content remaining in a container in accordance with the embodiment depicted in FIG. 2B.

FIG. 4 illustrates processing operations associated with a Tap and Swipe Method of recording the proportion of content remaining in a container in accordance with an embodiment of the present patent application.

FIG. 5 illustrates processing operations associated with a Drag and Hold Method of recording the proportion of content remaining in a container in accordance with an embodiment of the present patent application.

FIG. 6 illustrates processing operations associated with a Slider Bar Method of recording the proportion of content remaining in a container in accordance with an embodiment of the present patent application.

FIG. 7A illustrates a user interface of a setup process of the Linear Method of calculating the proportion of content remaining in a container depicted in FIG. 2A.

FIG. 7B illustrates another user interface of a setup process of the Linear Method of calculating the proportion of content remaining in a container depicted in FIG. 2A.

FIG. 7C illustrates a user interface of a setup process of the Area Method of calculating the proportion of content remaining in a container depicted in FIG. 2B.

FIG. 8A illustrates a user interface (of the Tap and Swipe method) of a recording and calculating process of calculating the proportion of content remaining in a container.

FIG. 8B illustrates another user interface (of the Tap and Swipe method) of a recording and calculating process of calculating the proportion of content remaining in a container.

FIG. 8C illustrates yet another user interface (of the Tap and Swipe method) of a recording and calculating process of calculating the proportion of content remaining in a container.

FIG. 8D illustrates still another user interface (of the Tap and Swipe method) of a recording and calculating process of calculating the proportion of content remaining in a container.

FIG. 8E illustrates still another user interface (of the Tap and Swipe method) of a recording and calculating process of calculating the proportion of content remaining in a container.

FIG. 8F illustrates still another user interface (of the Tap and Swipe method) of a recording and calculating process of calculating the proportion of content remaining in a container.

FIG. 9A illustrates a user interface (of the Hold and Drag method) of a recording and calculating process of calculating the proportion of content remaining in a container.

FIG. 9B illustrates another user interface (of the Hold and Drag method) of a recording and calculating process of calculating the proportion of content remaining in a container.

FIG. 9C illustrates yet another user interface (of the Hold and Drag method) of a recording and calculating process of calculating the proportion of content remaining in a container.

FIG. 9D illustrates still another user interface (of the Hold and Drag method) of a recording and calculating process of calculating the proportion of content remaining in a container.

FIG. 10 illustrates a user interface (of the Slide Bar method) of a recording and calculating process of calculating the proportion of content remaining in a container.

### DETAILED DESCRIPTION

Reference will now be made in detail to a preferred embodiment of the system and the method for inventory counting disclosed in the present patent application, examples of which are also provided in the following description. Exemplary embodiments of the system and the method for inventory counting disclosed in the present patent application are described in detail, although it will be apparent to those skilled in the relevant art that some features that are not particularly important to an understanding of the system and the method for inventory counting may not be shown for the sake of clarity.

Furthermore, it should be understood that the system and the method for inventory counting disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

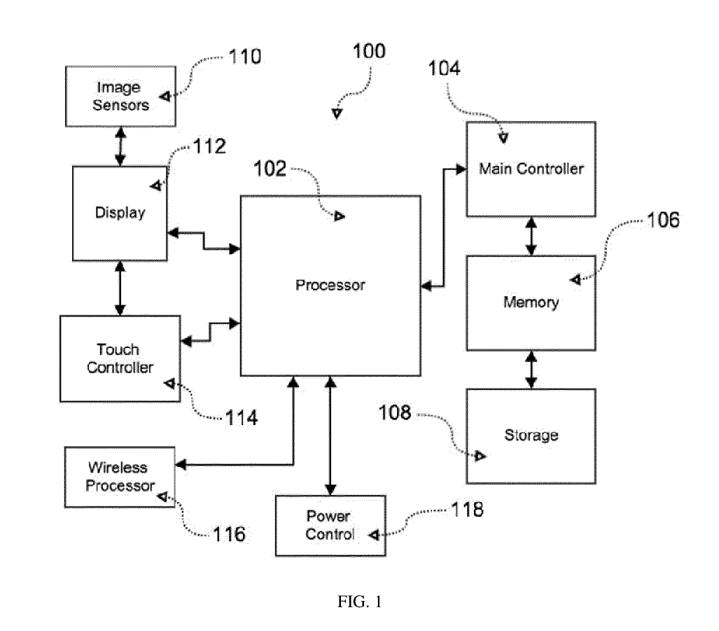

FIG. 1 illustrates an electronic system 100 in accordance with an embodiment of the present patent application. In one embodiment, the electronic system 100 is a smartphone including a touch controller 114, a processor 102 in communication with the touch controller 114, and a main controller 104. The processor 102 may be a central processing unit and/or a graphics processing unit. The main controller 104 implements operations of the electronic system 100. The main controller 104 communicates with the memory 106, which is a combination of flash memory and random access memory. The memory is connected to a non-transient computer-readable storage medium 108. Examples of computer-readable storage mediums include, but are not limited to: databases or folders in local or cloud storages.

The main controller 104 communicates with the processor 102 regarding haptic signals applied to the display 112, which are recorded by the touch controller 114. The main controller 104 includes executable instructions executed by the processor to present different elements on the display 112 based upon the processing of haptic signals.

The electronic system 100 may also include other components commonly associated with a smartphone, such as an image sensor 110, a wireless signal processor 116 and a power control circuit 118.

Two methods are provided for calculating the proportion of content remaining in a container regardless of its shape or size through the use of an electronic system. The methods are referred to as the Linear Method and the Area Method. Each method includes 2 processes: a setup process and a recording and calculating process.

The Linear Method requires that the y-coordinates of the full and empty level of the content within the container of an item be defined relative to an image of it in order to calculate its proportion.

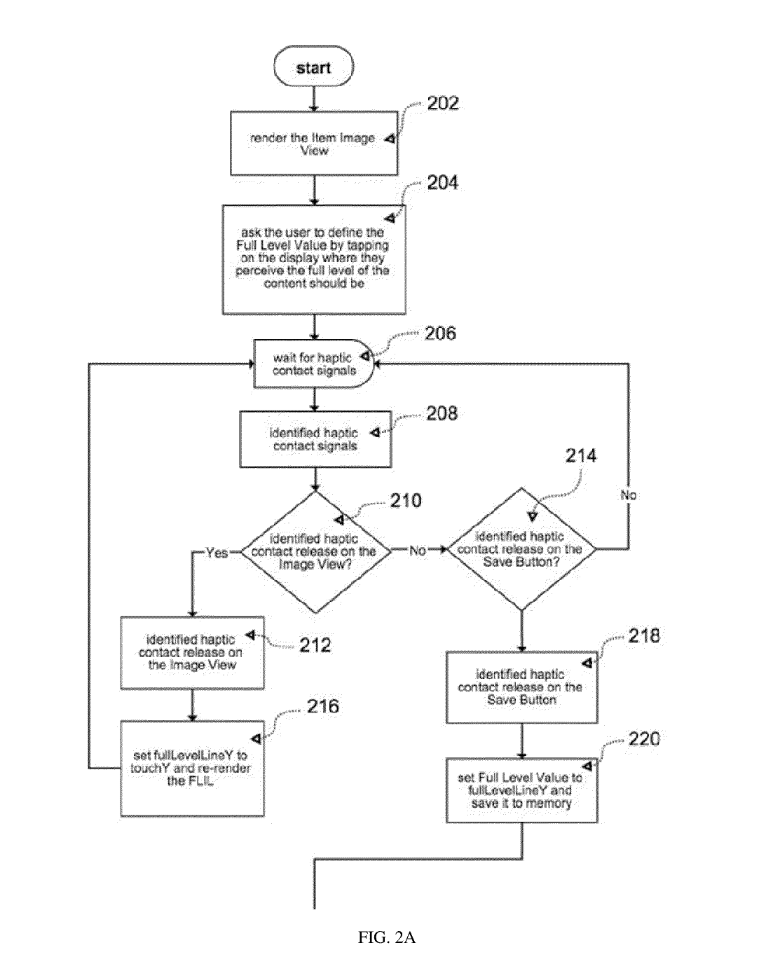

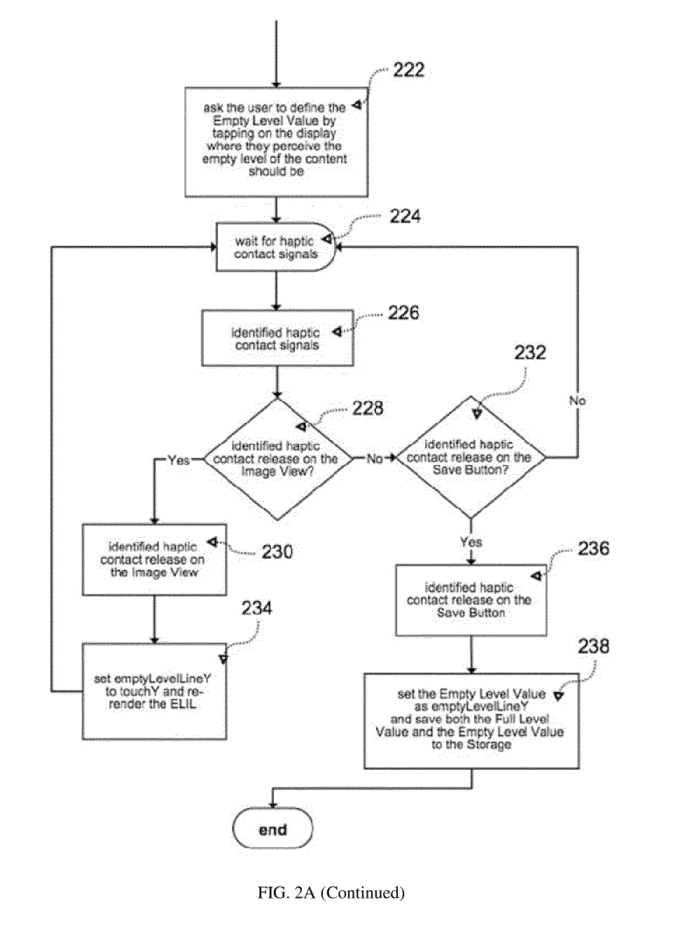

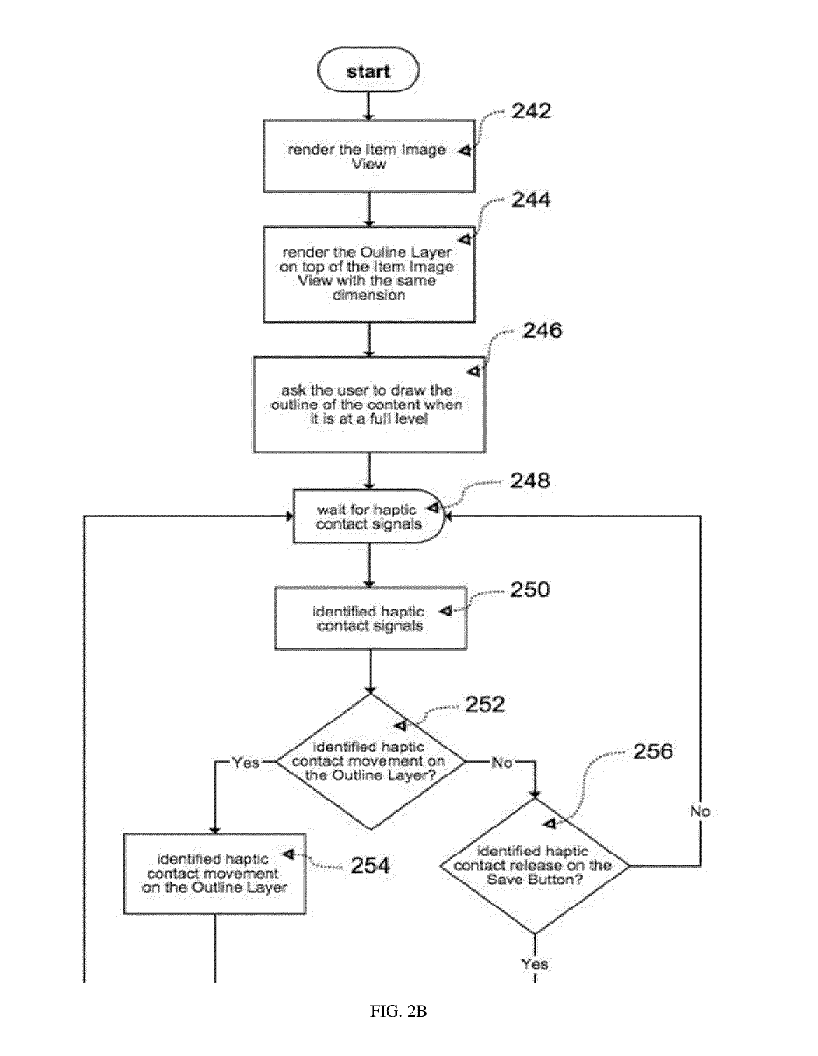

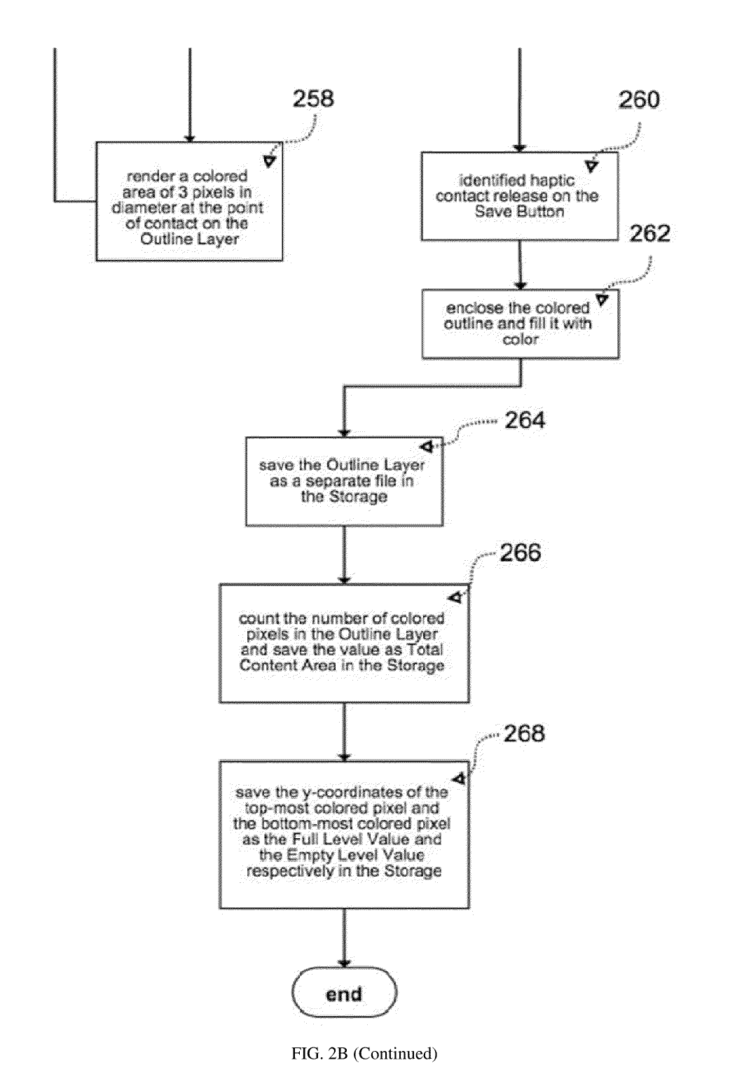

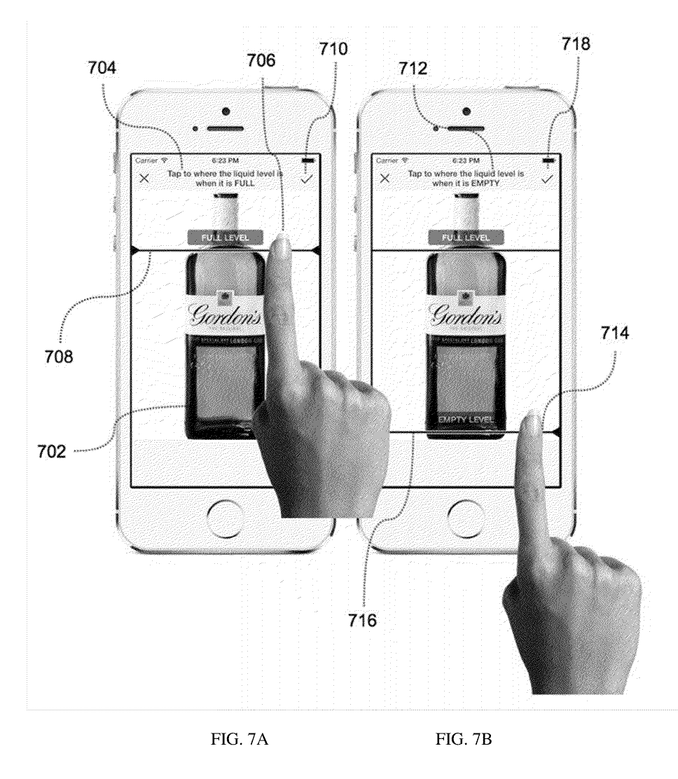

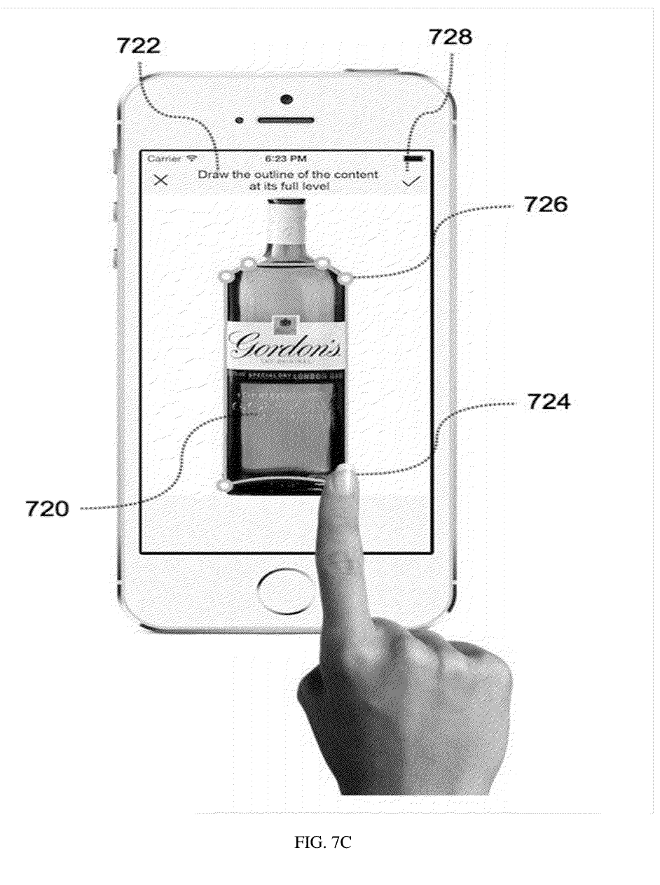

FIG. 2A illustrates processing operations associated with the setup process for the Linear Method of calculating the proportion of content remaining in a container in accordance with an embodiment of the present patent application. In this embodiment, the electronic system 100 is a smartphone. The method for inventory counting is executed by a stock taking application that runs on the electronic system 100. FIG. 7A illustrates a user interface of the setup process of the Linear Method of calculating the proportion of content remaining in a container depicted in FIG. 2A.

Referring to FIG. 2A and FIG. 7A, the setup process begins with the presentation of an Item Detail View, which shows an image 702 of an item, i.e. a container (step 202). A user is asked to tap on the display 112 where the full level of the content is 704 (step 204). The user taps on the display 112 where the full level is perceived to be 706 (step 212) to define the Full Level Value (y-coordinate of the full level). That value is assigned to fullLevelLineY (y-coordinate of the FLIL, or Full Level Indicator Line) 708, and the processor 102 re-renders the FLIL at the point of contact to visually represent where the user has selected the full level 708 to be (step 216). The user then taps a checkmark at the top 710 (step 218) to temporarily save that value in the Memory 106 (step 220). It is understood that the image 702 of the container in the Item Detail View is a virtual object representing the container.

Referring to FIG. 7B, the user is then asked to tap on the display 112 where the empty level 712 of the content is (step 222). The user taps on where the empty level is perceived to be 714 (step 230) to define the Empty Level Value (y-coordinate of the empty level). That value is assigned to the emptyLevelLineY (y-coordinate of the ELIL, or Empty Level Indicator Line 716) takes that value, and the processor 102 re-renders at the point of contact to visually represent where the user has selected the empty level 716 to be (step 234). The user then taps the checkmark 718 again (step 236), and this time both the Full Level Value and Empty Level Value are saved to the database in the Storage 108 permanently until the next time they are changed (step 238).

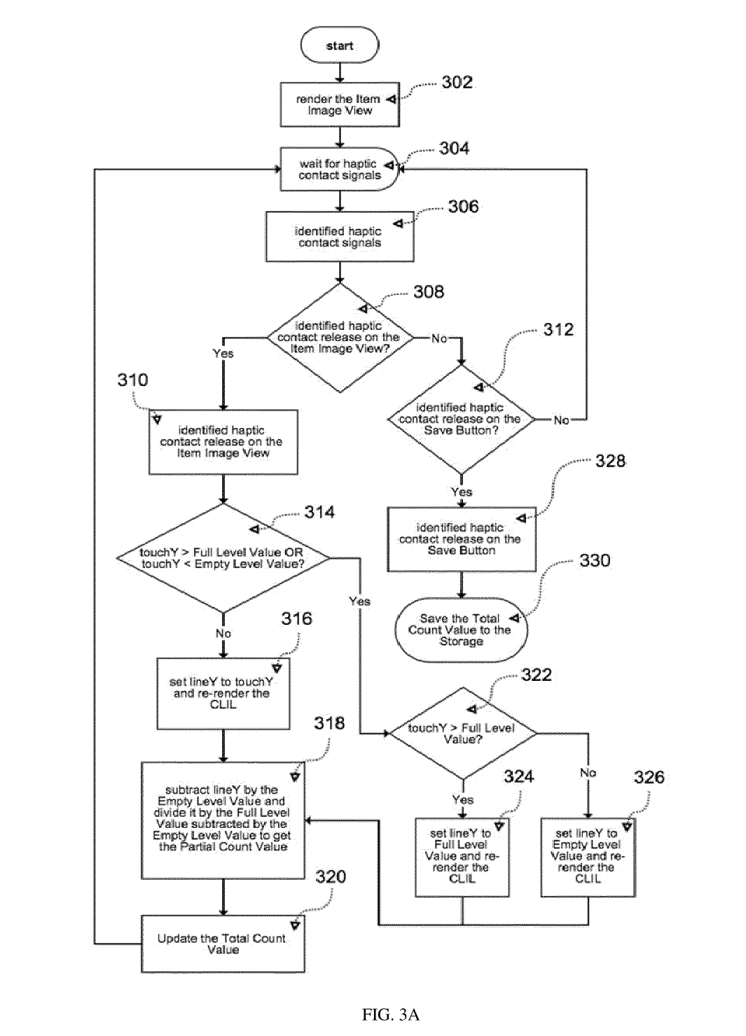

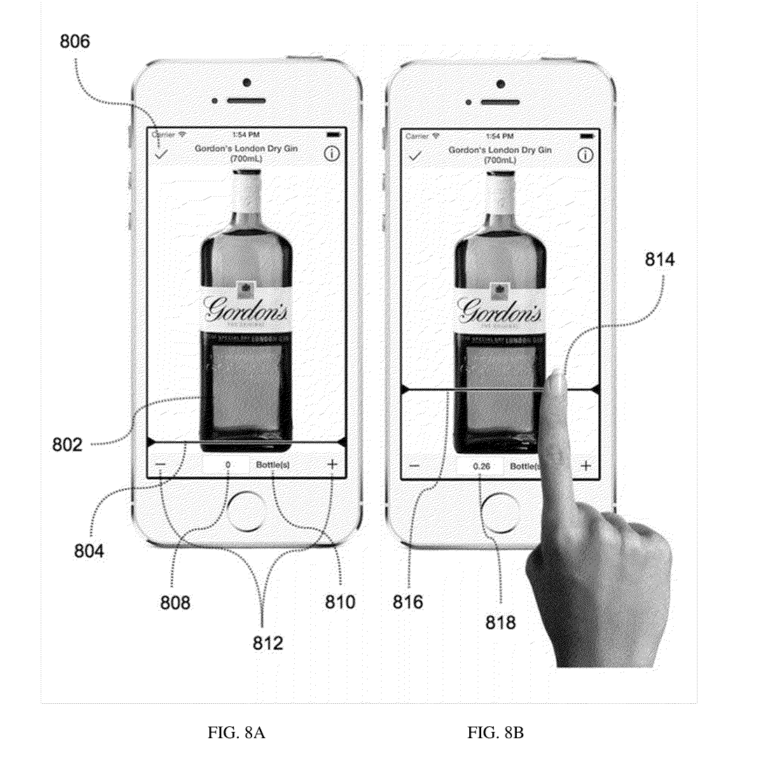

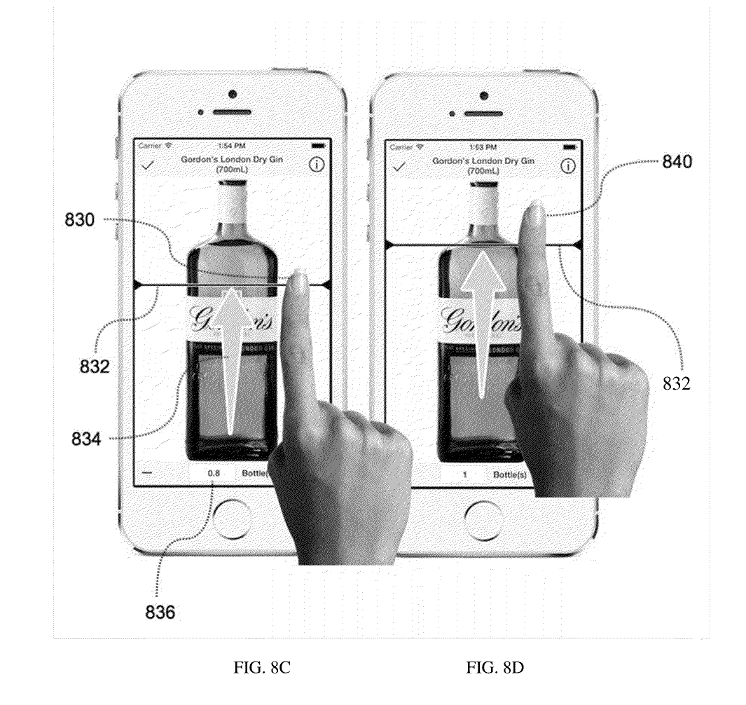

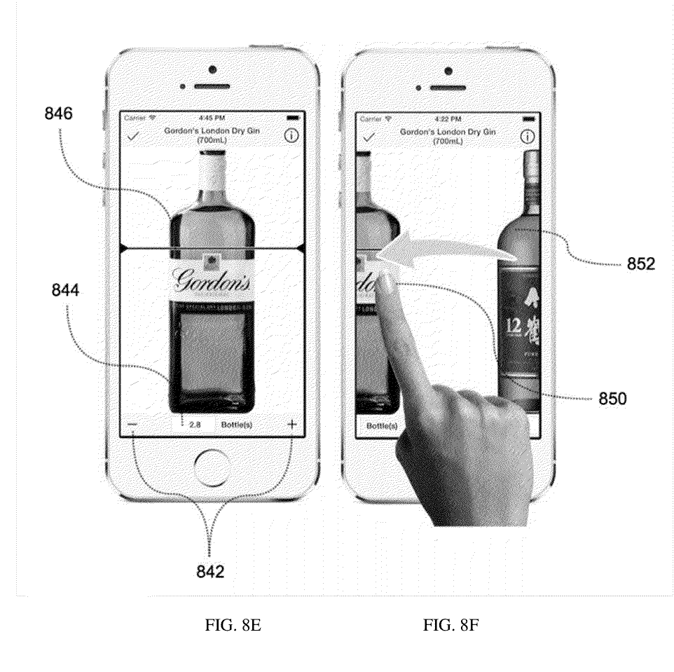

FIG. 3A illustrates processing operations associated with a recording and calculating process for the Linear Method of calculating the proportion of content remaining in a container in accordance with the embodiment depicted in FIG. 2A. FIG. 8A illustrates a user interface of a recording and calculating process of calculating the proportion of content remaining in a container. FIG. 8B illustrates another user interface of a recording and calculating process of calculating the proportion of content remaining in a container. Referring to FIG. 8A, the user is once again presented with an image of the item 802. But this time, a digitally rendered line, or CLIL (Content Level Indicator Line), also overlays the image to visually represents where the current content level 804 is.

Referring to FIG. 3A and FIG. 8B, when the user “taps” (haptic contact engagement followed by haptic contact release) on the display 814 (step 310), touchY (y-coordinate of the haptic contact signal relative to the image) is assigned to lineY (y-coordinate of the CLIL) (step 316). The CLIL is then re-rendered on the display with the updated y-coordinate 816 to reflect the change caused by the “tap” action (step 316).

The CLIL is bounded by the Full Level Value and the Empty Level Value. So when the point of contact is above and below these levels respectively (step 314), lineY will equate to these points, and CLIL will render exactly at these levels. That is, if touchY is above the Full Level Value, lineY will be set to the Full Level Value (step 324), and if touchY is below the Empty Level Value, lineY will be set to the Empty Level Value (step 326).

The Partial Count Value (proportion value of the remaining content) is obtained by taking the updated lineY and subtracting that by the Empty Level Value and dividing that by the height of the content level (Full Level Value−Empty Level Value) (step 318). The equation is as follows:

Partial Count Value=(lineY−Empty Level Value)/(Full Level Value−Empty Level Value)

At the full level, the Partial Count Value is equal to 1, while at the empty level, it is equal to 0. It is understood that the above calculation is executed by the processor 102 in FIG. 1.

The Area Method requires that the area of the content within the container of the item at its full level be defined relative to an image of it in order to calculate its proportion. FIG. 2B illustrates processing operations associated with a setup process for the Area Method of calculating the proportion of content remaining in a container implemented in accordance with an embodiment of the present patent application. FIG. 7C illustrates a user interface of a setup process of the Area Method of calculating the proportion of content remaining in a container depicted in FIG. 2B. Similarly, in this embodiment, the electronic system 100 here is a smartphone, and the method for inventory counting is implemented by a stock taking application that runs on it.

Referring to FIG. 2B and FIG. 7C, the setup process begins with the presentation of an Item Image View, which shows an image 720 of an item, i.e. a container, along with an Outline Layer, which is a transparent layer that is created over the image 720 with the same dimensions as the image 720 (step 242). The user is asked to draw on the display 112 the outline of the content when it is at its full level 722 (step 246). The user draws the outline 724 of the content on the Outline Layer (step 254), and the haptic contact signal is registered and the processor 102 renders a digital outline 726 along the places of contact (step 258). After the outline of the content is drawn and the user taps the checkmark button 728 (step 260), the processor fills this outline with colored pixels behind the scenes (step 262). This Outline Layer is then saved as a separate file (step 264) in the storage 108. The pixels with color are then counted and the resulting total number of pixels (Full Content Value) is then saved to the database in the storage (step 266). This number represents the total volume of content of the container at a full state. The y-coordinates of the top-most pixel and bottom-most pixel of the outline are also saved to the database, recorded as Full Level Value and Bottom Level Value (step 268). It is understood that the image 720 of the container in the Item Image View is a virtual object representing the container.

In the recording and calculating process of the Area Method, just like in the Linear Method, the user is presented with an image of the item. The Outline Layer saved earlier from the setup process is also retrieved from the storage 108. FIG. 3B illustrates processing operations associated with a recording and calculating process for the Area Method of calculating the proportion of content remaining in a container in accordance with the embodiment depicted in FIG. 2B. Referring to FIG. 3B and FIG. 8B, upon haptic contact release 814 (step 350), lineY updates (step 356) and the number of colored pixels below the CLIL (y-coordinate less than lineY) is counted to give the Remaining Content Value (step 358). This value is then divided by the Full Content Value (the total number of pixels for full content) previously stored, outputting the Partial Count Value (step 360). The equation is as follows:

Partial Count Value=Remaining Content Value/Full Content Value

The present patent application further provides embodiments of three methods of recording the count data from the user, namely the Tap and Swipe Method, the Hold and Drag Method, and the Slide Bar Method.

According to an embodiment, the Tap and Swipe Method introduces a highly efficient way of counting items. The method includes three 3 key mechanisms:

Ordering Items

The Tap & Swipe Method enables different sections to be created, wherein each section, items can be ordered the same way they are arranged in the establishment. An example of a section is the Top Shelf of the Main Bar or the Back Fridge in the Storage. Once items are ordered, they are primed for quick and efficient stock counting.

Tap (or Drag)

One gesture is all that is needed to record and calculate the Partial Count Value of an item. All the user needs to do is “tap” on the image of the item where the remaining level of the content is 814, referring to FIG. 8B. No more “eyeballing” (estimating the proportion by looking at it) or manually writing or typing in data is needed.

In certain instances, referring to FIG. 8C, dragging 832 provides a better control of the CLIL and allows a more precise release.

Swipe

One gesture is all that is needed to move to the next item to count. Compared to conventional methods of searching through a list of items on a piece of paper or typing in an item name and searching for it on an electronic system, where multiple gestures or keystrokes are required, this method is a lot more efficient.

Swiping left will transition to the next item on the right (850 in FIG. 8F), swiping right will transition to the previous item on the left.

Since the items are ordered, all a user needs to do is stand in front of the line of items, look at the content level, tap on an image of it and swipe to the next item. This is one of the fastest ways to do serial counting of items. FIGS. 8A-8F shows how quick and easy the counting process is. Only two gestures are required to count an item and have the next one pulled up ready for counting.

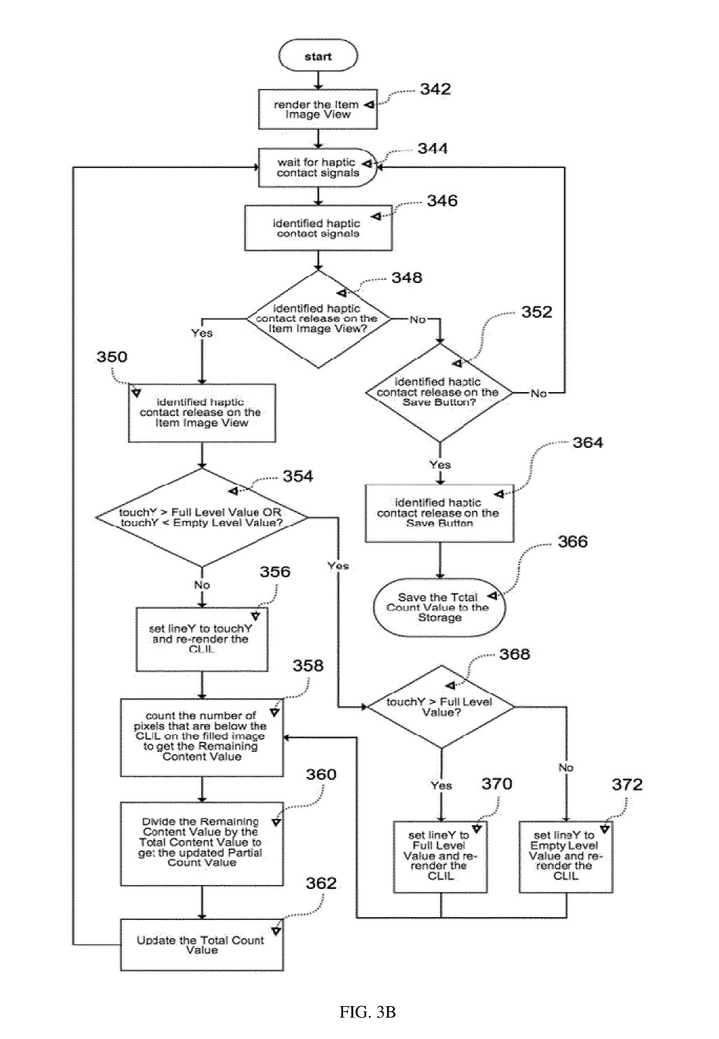

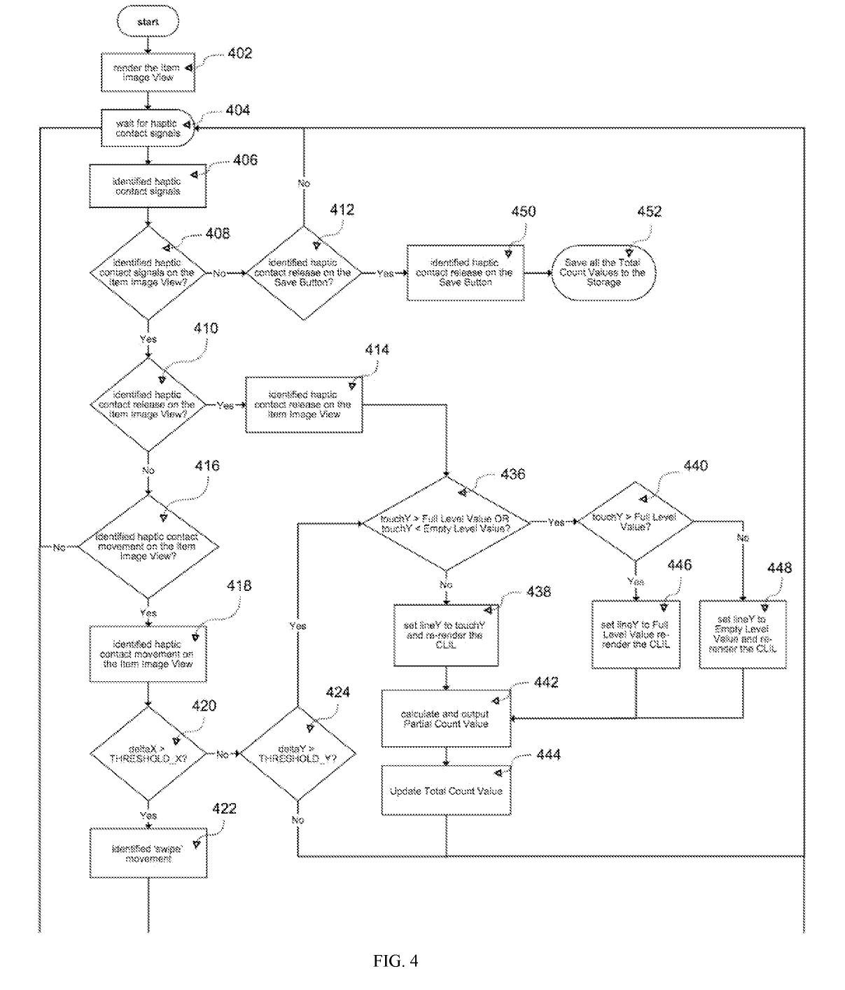

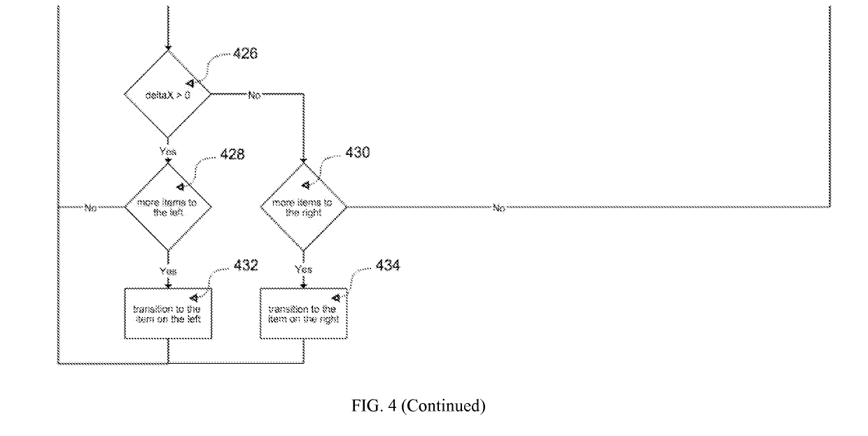

FIG. 4 illustrates processing operations associated with a Tap and Swipe Method of recording the proportion of content remaining in a container in accordance with an embodiment of the present patent application. Referring to FIG. 4, when haptic contact movement on the Item Image View is detected (step 418), the change in touchY (deltaY) and touchX (deltaX) is evaluated to determine the intent of the user. If the absolute value of deltaY is larger than thresholdY (an arbitrary number defining the change in vertical distance required to move the CLIL) (step 424), the CLIL gets moved. If the absolute value of deltaX is larger than thresholdX (an arbitrary number defining the change in horizontal distance requires to determine a swipe intent) (step 420), a “swipe” intent is determined (step 422). If deltaX is a positive number, a check is made to see if there are additional items to the left (step 428), if there are, a transition is made and the item to the left is moved to the screen via a slide animation (step 432). If deltaX is a negative number, a check is made to see if there are additional items to the right (step 430), if there are, a transition is made and the item to the right is moved to the screen via a slide animation (step 434). It is understood that deltaY and deltaX described above are haptic displacements associated with the swiping gesture.

Another embodiment of the present patent application allows easy inputting of not just partial counts, but also whole counts. Referring to FIG. 8E, the Whole Count Value can be changed by tapping on the plus (+) or minus (−) buttons on the toolbar 842. Upon haptic contact release, the Total Count Value will either increase by 1 or decrease by 1.

Referring to FIG. 8E, the Total Count Value can also be changed by tapping on the field 844, whereby a number pad appears to allow a user to freely enter any number in it. The CLIL 846 will re-render to reflect any changes made to the Total Count Value by the number pad.

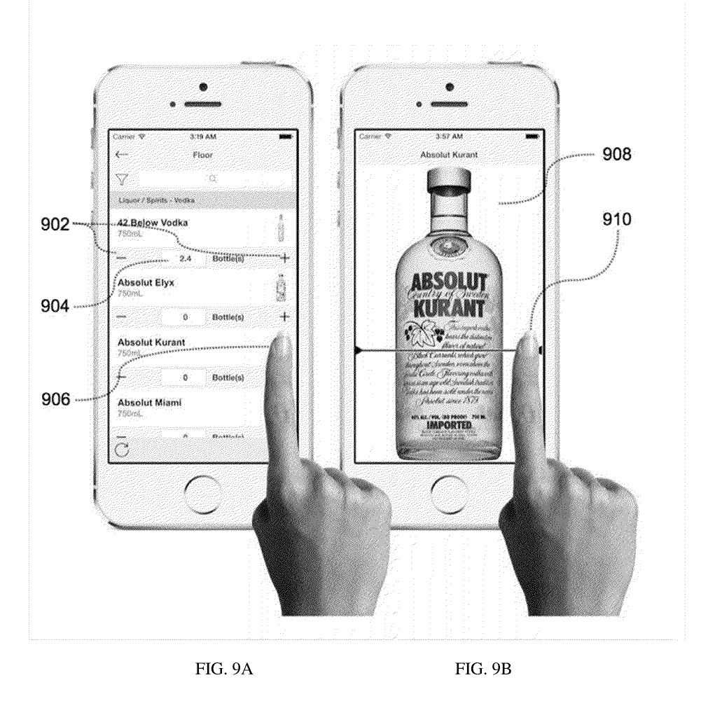

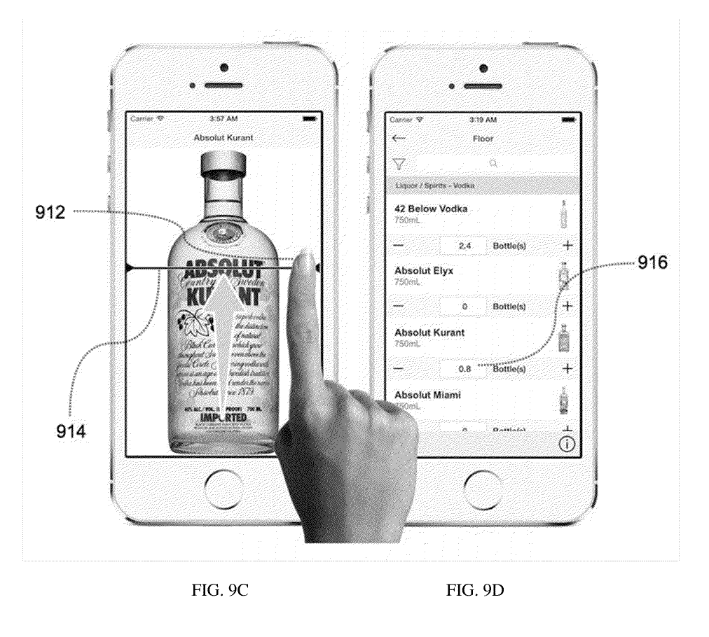

The Hold and Drag method of recording the proportion of content remaining in a container is illustrated in FIGS. 9A-9D. Items are listed out in a List View, which is typically described as a list of items rendered row-by-row one after another in a view, referring to FIG. 9A. In this embodiment, the Whole Count value can be changed quickly outside in the list by tapping on the plus (+) or minus (−) buttons on the toolbar 902, without having to go inside a detail view of the item. The Total Count Value can also be changed by tapping on the text field 904 that contains it, whereby a number pad appears to allow a user to freely enter any number in it.

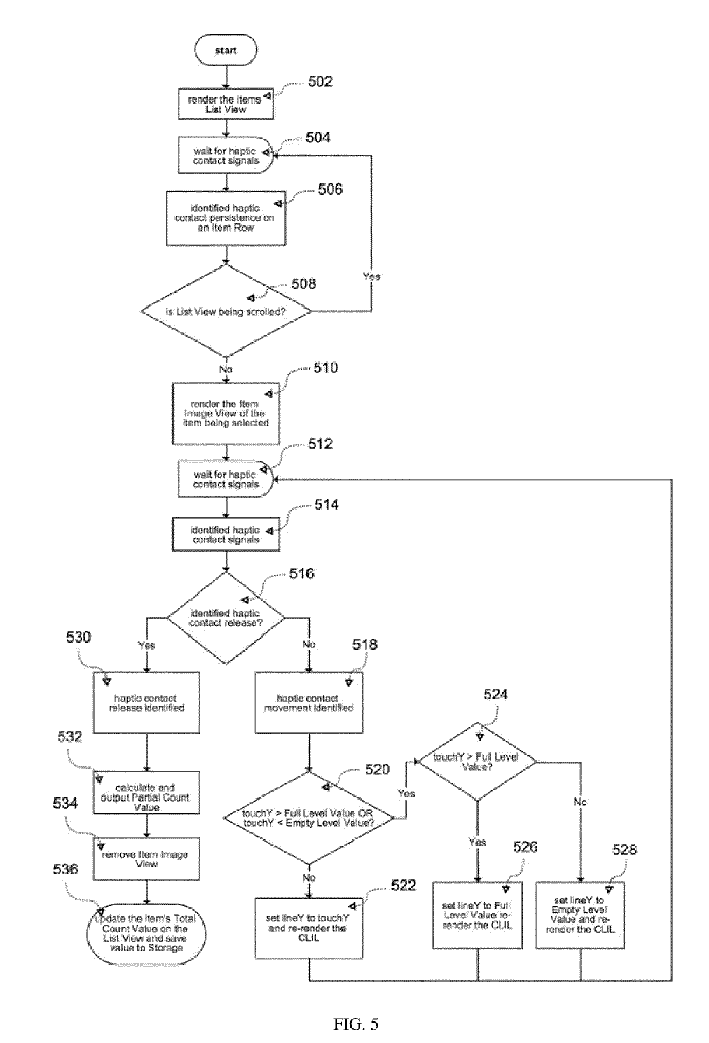

FIG. 5 illustrates processing operations associated with a Drag and Hold Method of recording the proportion of content remaining in a container in accordance with an embodiment of the present patent application. Referring to FIG. 5 and FIGS. 9A-9D, the unique proposition here is that upon haptic contact persistence (touch and hold) on the row 906 (step 506), a view containing the image of the item renders on top 908 (step 510). And while haptic contact 910 is still persistent (finger still touching the display), the user can drag the finger (haptic contact movement) (step 518) to adjust the content level 912. Once the user moves the CLIL to the desired content level 914 (step 522), the user releases the finger from the display (haptic contact release) (step 530), and the image view disappears (step 534), as shown in FIG. 9D. The proportion value is generated based on the method of calculation used (the Linear Method or the Area Method) (step 532) as described in foregoing paragraphs. The Total Count Value 916 outside updates according to this new Partial Count Value as well (step 536).

The Slide Bar Method offers a way to count items partially inline a List View. The aim is to improve the speed of partial counting by eliminating the need to tap into an item before doing the counting and doing as few gestures as possible.

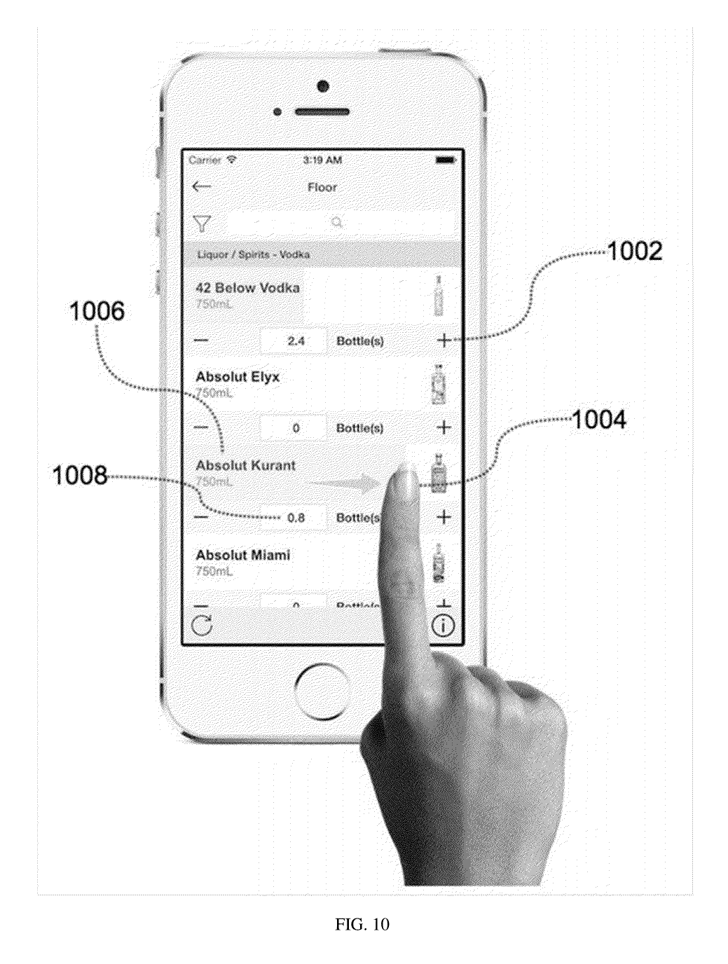

FIG. 10 illustrates a user interface (of the Slide Bar method) of a recording and calculating process of calculating the proportion of content remaining in a container. Referring to FIG. 10, in this embodiment, similar to the other 2 methods, the Whole Count Value can be changed by tapping on the plus (+) or minus (−) buttons on the toolbar 1002. The Total Count Value can also be changed by tapping on the text field that contains it 1008, whereby a number pad appears to allow a user to freely enter any number in it.

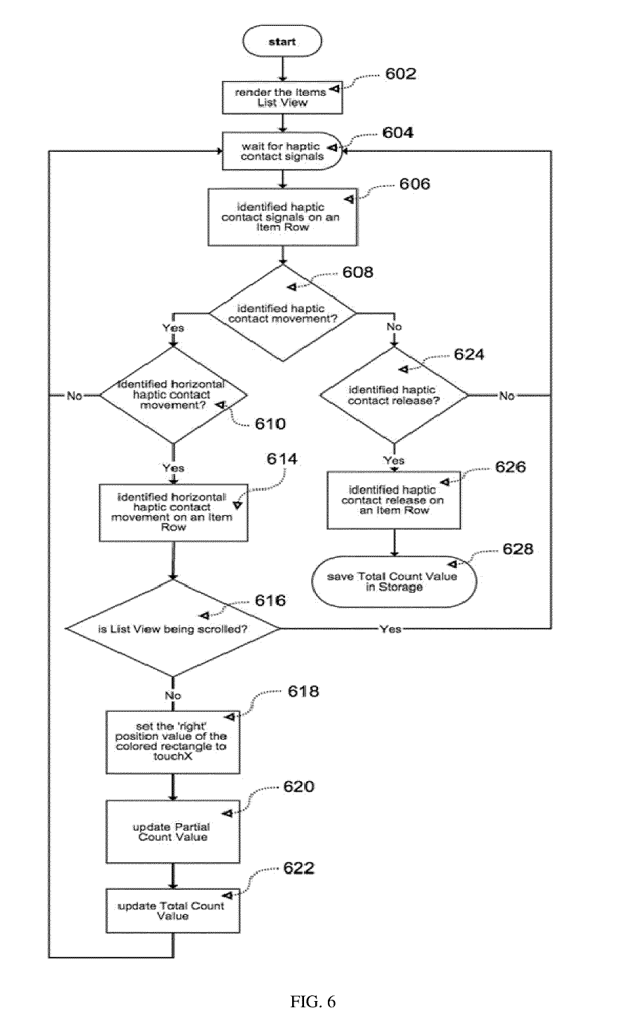

FIG. 6 illustrates processing operations associated with a Slider Bar Method of recording the proportion of content remaining in a container in accordance with an embodiment of the present patent application. Referring to FIG. 6 and FIG. 10, the unique proposition here is the ability to record content proportion directly within the row itself. A user simply drags the finger across a row in an item list (step 614) to record content proportion 1004 (step 620). The row identifies haptic contact movement and adjusts the “right” position (distance of its right edge from the container's right edge) (step 618) of a colored, translucent box (thus the width) that overlays the row 1006.

One embodiment of this recording method includes dividing the width of the colored box by the width of the row to generate the Partial Count Value, as follows:

Partial Count Value=Colored Overlay Box Width/Row Width

The Partial Count Value is immediately added up to the Whole Count Value and the Total Count Value 1008 is updated in real-time (step 622). In other words, a total amount of the content remaining in different containers in a list of items is updated based on the amount of content remaining in each container in the list. It is understood that each row described above is a virtual object representing a container.

Another embodiment allows for 10 different values for the width of the colored box: 0.1, 0.2, 0.3, 0.4, 0.5, 0.6, 0.7, 0.8, 0.9 and 1. As the finger is dragged across a row (step 604), the “right” position, and therefore the width of the box changes with the haptic contact signal, but in a way that “snaps” to the nearest interval value. In other words, the row is divided into a predetermined number (10 in this embodiment) of intervals, while the box only overlays one or a plurality of the intervals within the row. The Total Count Value 1008 also updates on each “snap”. Limiting the box's width to only 10 variations has the benefit of keeping things simpler. While this method of recording still depends on the “eyeballing” technique to judge content proportion (when it comes to counting bottles of liquid), anything more precise than a tenth of a unit is not going to be accurate anyway with this technique.

While the present patent application has been shown and described with particular references to a number of embodiments thereof, it should be noted that various other changes or modifications may be made without departing from the scope of the present invention.

What is claimed is:

1. A method for inventory counting comprising:
representing a container by an image of the container displayed on a display;
setting up a full level of a content on the image corresponding to the content being considered full in the container by making a first haptic gesture to the display;
setting up an empty level of the content on the image corresponding to the container being considered empty of the content by making a second haptic gesture to the display;
determining a current level of the content remaining in the container on the image and marking the current level by making a third haptic gesture to the display;
calculating a proportion of the content remaining in the container based on the current level, the full level and the empty level on the image; and
recording the calculated proportion of the content remaining in the container.

2. The method for inventory counting of claim 1, wherein the first, second, and third haptic gestures comprise a tapping gesture or a dragging gesture.

3. The method for inventory counting of claim 1, wherein coordinates of the current level, the full level and the empty level on the image in a depth direction of the container are used in calculating the proportion of the content remaining in the container.

4. The method for inventory counting of claim 1 further comprising switching to processing another image representing another container based on a swiping gesture.

5. The method for inventory counting of claim 4 further comprising determining whether to switch to the other image based on whether absolute value of a haptic displacement associated with the swiping gesture is greater than a predetermined threshold; and determining whether to switch to a left image or switch to a right image based on whether the haptic displacement is positive or negative.

6. A method for inventory counting comprising:
representing a container by a virtual object displayed on a display;
setting up a full level of a content on the virtual object corresponding to the content being considered full in the container by making a first haptic gesture to the display;
determining a current level of the content remaining in the container on the virtual object and marking the current level by making a second haptic gesture to the display; and
calculating and recording a proportion of the content remaining in the container based on the current level and the full level on the virtual object.

7. The method for inventory counting of claim 6, wherein the virtual object is an image of the container or a row in an item list.

8. The method for inventory counting of claim 7 further comprising adjusting width of a colored translucent box that overlays the row by a user with a haptic gesture, wherein width of the row represents the full level of the content in the container, while the width of the box represents the current level of the content remaining in the container.

9. The method for inventory counting of claim 8, wherein the row is divided into a predetermined number of intervals, while the box only overlays one or a plurality of the intervals within the row.

10. The method for inventory counting of claim 7 further comprising updating a total amount of the content remaining in different containers in a list of items based on the amount of content remaining in each container in the list.

11. The method for inventory counting of claim 6 further comprising setting up an empty level of the content on the virtual object corresponding to the container being considered empty of the content by making a third haptic gesture to the display, wherein coordinates of the current level, the full level and the empty level in a depth direction of the virtual object are used in calculating the proportion of the content remaining in the container.

12. The method for inventory counting of claim 11, wherein the current level is determined to be equal to the full level if a coordinate associated with the second haptic gesture is greater than the coordinate of the full level; while the current level is determined to be equal to the empty level if the coordinate associated with the second haptic gesture is smaller than the coordinate of the empty level.

13. The method for inventory counting of claim 6 further comprising defining an outline on an outline layer over the virtual object when the content in the container is at the full level, filling the outline with colored pixels, and counting the number of colored pixels.

14. The method for inventory counting of claim 13 further comprising counting number of pixels below the current level within the outline.

15. The method for inventory counting of claim 6, wherein the first and second haptic gestures comprise a tapping gesture or a dragging gesture.

16. A system for inventory counting comprising:
a display;
a touch controller;
a processor in communication with the touch controller; and
a main controller in communication with the processor regarding haptic signals applied to the display and recorded by the touch controller; wherein:
the processor is configured to represent a container by an image of the container and display the image on a display; set up a full level of a content on the image corresponding to the content being considered full in the container by a haptic gesture from a user; set up an empty level of the content on the image corresponding to the container being considered empty of the content by a haptic gesture from the user; determine a current level of the content remaining in the container on the image indicated by a haptic gesture from the user;
calculate a proportion of the content remaining in the container based on the current level, the full level and the empty level on the image; and record the calculated proportion of the content remaining in the container.

17. The system for inventory counting of claim 16, wherein the first, second, and third haptic gestures comprise a tapping gesture or a dragging gesture.

18. The system for inventory counting of claim 16, wherein the processor is configured to calculate the proportion of the content remaining in the container based on coordinates of the current level, the full level and the empty level on the image in a depth direction of the container.

19. The system for inventory counting of claim 16, wherein the processor is configured to switch to processing another image representing another container based on a swiping gesture.

20. The system for inventory counting of claim 19, wherein the processor is configured to determine whether to switch to the other image based on whether absolute value of a haptic displacement associated with the swiping gesture is greater than a predetermined threshold; and to determine whether to switch to a left image or switch to a right image based on whether the haptic displacement is positive or negative.
